(19) United States
(12) Patent Application Publication
(10) Pub. No.: US 2011/0058124 A1
(43) Pub. Date: Mar. 10, 2011

(54) COMPOSITE OPTICAL DEVICE AND MONITOR

(75) Inventors: Chung-Hung CHIEN, Taoyuan County (TW); Wen-Feng CHENG, Taoyuan County (TW)

(73) Assignee: Entire Technology Co., Ltd., Taoyuan County (TW)

(21) Appl. No.: 12/556,499

(22) Filed: Sep. 9, 2009

(51) Int. Cl. G02F 1/13357; F21V 7/04; F21V 7/22

(52) U.S. Cl. 349/64; 362/235; 362/97.2

(57) ABSTRACT

A composite optical device including pluralities of optical elements, pluralities of lighting devices, an emitting surface and a reflecting surface is provided. Each optical element including two first laterals, two second laterals, a third lateral and fourth lateral. The third lateral and the fourth lateral have a space respectively. The third lateral is adjacent to the fourth lateral of another optical element. Each lighting device is disposed inside the space. Whereby the third lateral and fourth lateral may receive the light energy of the lighting device and then the optical element delivers the light beam to the first lateral, the second lateral, the third lateral and the fourth lateral by means of the reflection of the reflecting surface. Finally, the light beam is output through the emitting surface.

### FIELD OF THE INVENTION

The present invention relates to composite optical device, particularly to a composite optical device receiving the light energy from its corner and to a monitor with composite optical device.

### DESCRIPTION OF THE PRIOR ART

LCD monitor only can work if the backlight module is provided. In the market, the monitor equipped with edge-type backlight module has recently come into vogue just because its weightlessness and thin character. For this reason, the edge-type backlight has attracted more and more interest and research. US patent US20070247871A1, for example, had disclosed an edge-type backlight module taking advantage of multiple LEDs disposing at lateral of light guide plate to generate light energy for a LCD monitor.

However, common used LEDs of prior art in the edge-type backlight module may cause so-called “Dark Band Phenomenon.” Please refer to FIG. 1, FIG. 1 is a diagram of “Dark Band Phenomenon” occurred in edge-type backlight module which adopts LEDs. As shown in FIG. 1, the “Dark Band Phenomenon” is what bright and dark alternate with between two LEDs; it may decrease the uniformity of luminance in edge-type backlight module and degrade the display efficiency of LCD monitor.

Thus, how to diminish the “Dark Band Phenomenon” and improve the display efficiency of the LCD monitor are critical issues remained to be resolved in the industry.

### SUMMARY OF THE INVENTION

The primary object of the invention is to diminish the “Dark Band Phenomenon” and improve the display efficiency of the LCD monitor.

To achieve the foregoing and other objects, a composite optical device is provided. The composite optical device comprises pluralities of optical elements, pluralities of lighting devices, an emitting surface and a reflecting surface. Each optical element includes a corresponding pair of surfaces, a corresponding pair of first laterals, a corresponding pair of second laterals, a corresponding third lateral and fourth lateral. Wherein at least one surface is connected to said first lateral, said second lateral, said third lateral and said fourth lateral. The side length of said third lateral is less than side length of said first lateral and said second lateral; the side length of said fourth lateral is less than side length of said first lateral and said second lateral. At least one third lateral and one fourth lateral has a space. Said third lateral is adjacent to the fourth lateral of another optical element. Each lighting device is disposed in said space. The emitting surface is one of corresponding pair of surfaces; the reflecting surface is another of corresponding pair of surfaces. Whereby at least one of said third lateral and said fourth lateral receive the light energy of said lighting device and then said optical element delivers the light beam to said first lateral, said second lateral, said third lateral and said fourth lateral by means of the reflection of said reflecting surface. The light beam is output through said emitting surface.

In the aforementioned composite optical device, wherein said reflecting surface or at least one lateral includes pluralities of microstructures, and said microstructures are convex or concave.

In the aforementioned composite optical device, wherein the pluralities of optical elements are arranged in order with the number of m in a first direction and with the number of n in a second direction; said first direction and said second direction are orthogonal to each other thereof; m:n is equal to 16:9 or 16:10.

In the aforementioned composite optical device, wherein said third lateral is connected to one of said corresponding pair of surfaces so as to form a first angle.

In the aforementioned composite optical device, wherein said fourth lateral is connected to one of said corresponding pair of surfaces so as to form a second angle.

In the aforementioned composite optical device, wherein material of said optical element is polymethyl methacrylate (PMMA), polycarbonate (PC), polystyrene (PS), polyethylene (PE) or mixture of at least two aforementioned materials.

To achieve the foregoing and other objects, another composite optical device is provided. The composite optical device comprises pluralities of optical elements, pluralities of lighting devices, an emitting surface and a reflecting surface. Each optical element includes a corresponding pair of surfaces, a corresponding pair of first laterals, a corresponding pair of second laterals, a corresponding third lateral and fourth lateral, a corresponding fifth lateral and sixth lateral. Wherein at least one surface is connected to said first lateral, said second lateral, said third lateral, said fourth lateral, said fifth lateral and said sixth lateral. The side length of said third lateral is less than side length of said first lateral and said second lateral; the side length of said fourth lateral is less than side length of said first lateral and said second lateral; the side length of said fifth lateral is less than side length of said first lateral and said second lateral; the side length of said sixth lateral is less than side length of said first lateral and said second lateral. At least one third lateral and one fourth lateral have a space. Said third lateral is adjacent to the fourth lateral of another optical element. At least one fifth lateral and one sixth lateral have a space. Said fifth lateral is adjacent to the sixth lateral of another optical element. Each lighting device is disposed in said space. The emitting surface is one of corresponding pair of surfaces; the reflecting surface is another of corresponding pair of surfaces. Whereby at least one of said third lateral, said fourth lateral, said fifth lateral and said sixth lateral receive the light energy of said lighting device and then said optical element delivers the light beam to said first lateral, said second lateral, said third lateral, said fourth lateral, said fifth lateral and said sixth lateral by means of the reflection of said reflecting surface. The light beam is output through said emitting surface.

In the aforementioned composite optical device, wherein said third lateral is connected to one of said corresponding pair of surfaces so as to form a first angle.

In the aforementioned composite optical device, wherein said fourth lateral is connected to one of said corresponding pair of surfaces so as to form a second angle.

In the aforementioned composite optical device, wherein said fifth lateral is connected to one of said corresponding pair of surfaces so as to form a third angle.

In the aforementioned composite optical device, wherein said sixth lateral is connected to one of said corresponding pair of surfaces so as to form a fourth angle.

To achieve the foregoing and other objects, a monitor with composite optical device is provided. The monitor comprises pluralities of optical elements, pluralities of lighting devices, an emitting surface, a reflecting surface, at least one optical diffusive layer and a LCD panel. Each optical element includes a corresponding pair of surfaces, a corresponding pair of first laterals, a corresponding pair of second laterals, a corresponding third lateral and fourth lateral. Wherein at least one surface is connected to said first lateral, said second lateral, said third lateral and said fourth lateral. The side length of said third lateral is less than side length of said first lateral and said second lateral; the side length of said fourth lateral is less than side length of said first lateral and said second lateral. At least one third lateral and one fourth lateral have a space. Said third lateral is adjacent to the fourth lateral of another optical element. Each lighting device is disposed in said space. An emitting surface is one of corresponding pair of surfaces; a reflecting surface is another of corresponding pair of surfaces. Whereby at least one of said third lateral and said fourth lateral receive the light energy of said lighting device and then said optical element delivers the light beam to said first lateral, said second lateral, said third lateral and said fourth lateral by means of the reflection of said reflecting surface. The light beam is output through said emitting surface. At least one optical diffusive layer is disposed outside said emitting surface; said optical diffusive layer receives the light energy emitted from said emitting surface so as to form a specific optical path. A LCD panel is disposed next to said optical diffusive layer; said LCD panel receives the optical path so as to present a predesigned image.

The composite optical device or monitor of present invention can diminish the “Dark Band Phenomenon,” and then improve the display efficiency of the LCD monitor. Therefore, it may have tremendous potential sells and market.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a diagram of “Dark Band Phenomenon” occurred in edge-type backlight module which adopts LEDs;

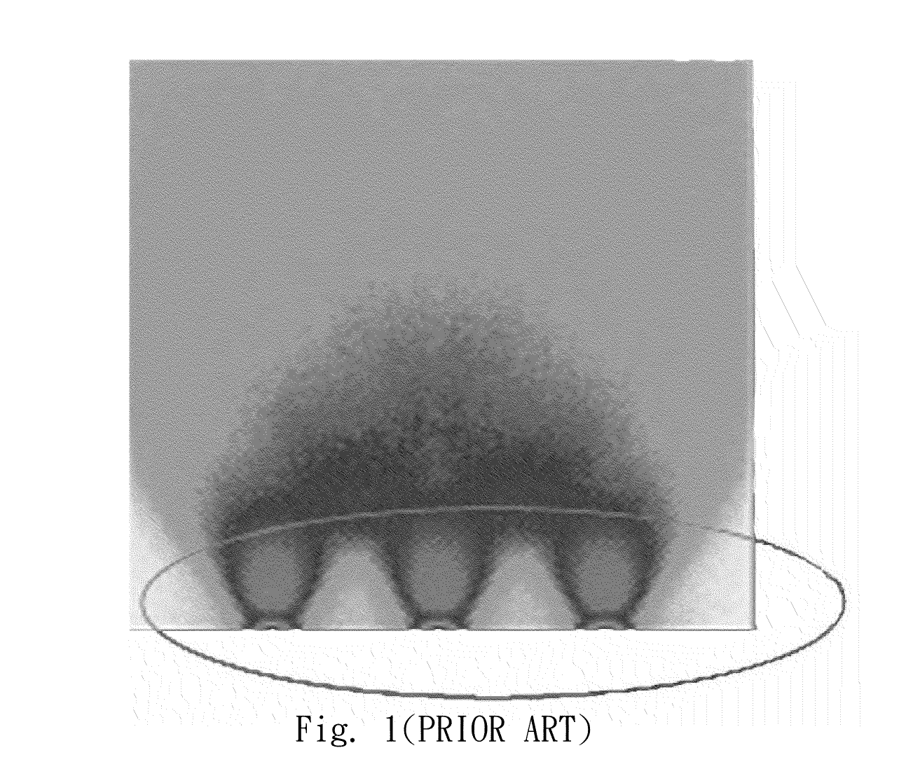

FIG. 2A is a perspective view of optical element in the composite optical device of first embodiment;

FIG. 2B is a top view of the composite optical device of first embodiment;

FIG. 2C is a perspective view of optical element in the composite optical device of second embodiment;

FIG. 2D is a perspective view of optical element in the composite optical device of third embodiment;

FIG. 2E is a perspective view of optical element in the composite optical device of fourth embodiment;

FIG. 3A is a perspective view of optical element in the composite optical device of fifth embodiment;

FIG. 3B is a top view of the composite optical device of fifth embodiment;

FIG. 4 is a perspective view of optical element in the composite optical device of sixth embodiment;

FIG. 5A is a perspective view of optical element in the composite optical device of seventh embodiment;

FIG. 5B is a top view of the composite optical device of seventh embodiment;

FIG. 6 is a perspective view of optical element in the composite optical device of eighth embodiment;

FIG. 7 is a perspective view of monitor with composite optical device;

FIG. 8 is a diagram of presenting benefit for adopting the composite optical device of first embodiment.

### DESCRIPTION OF THE PREFERRED EMBODIMENTS

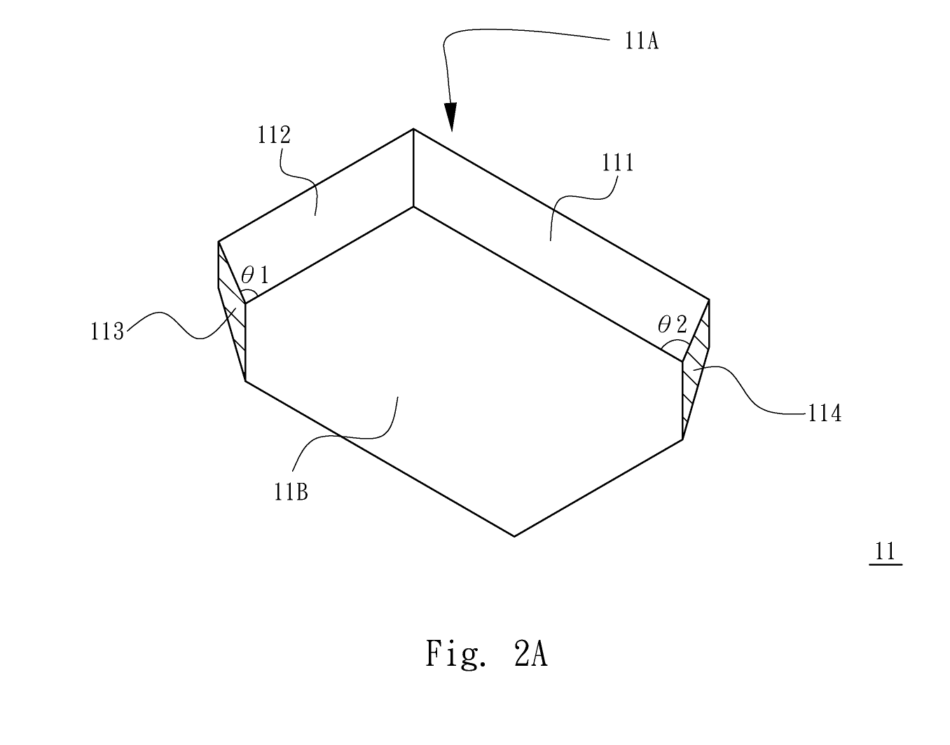

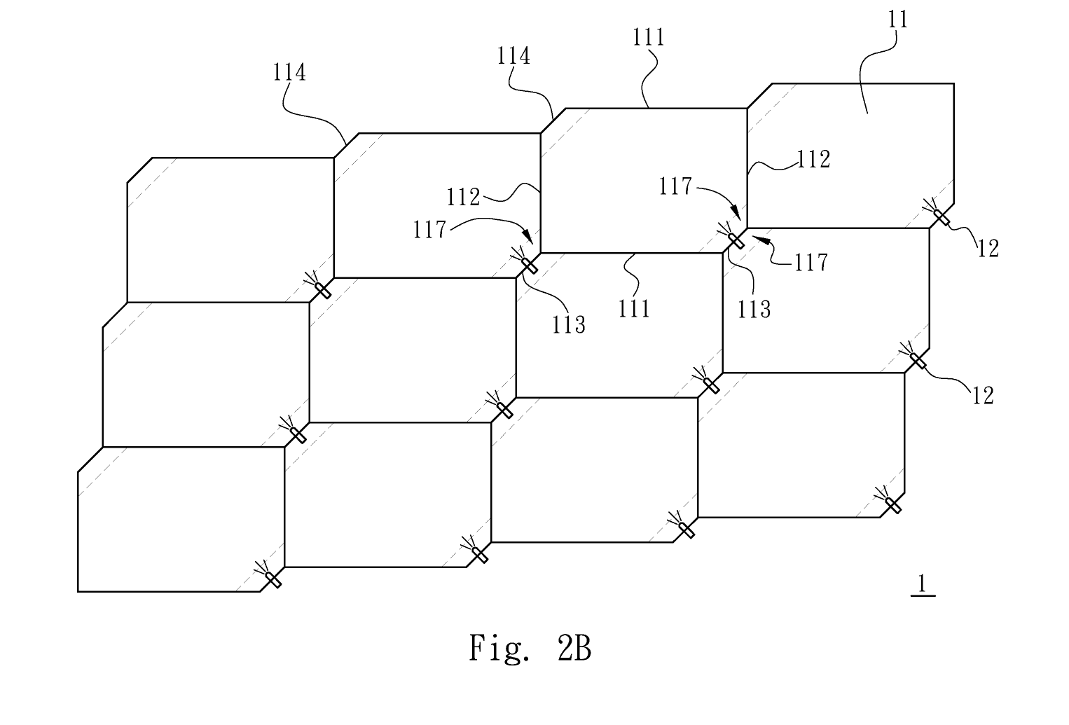

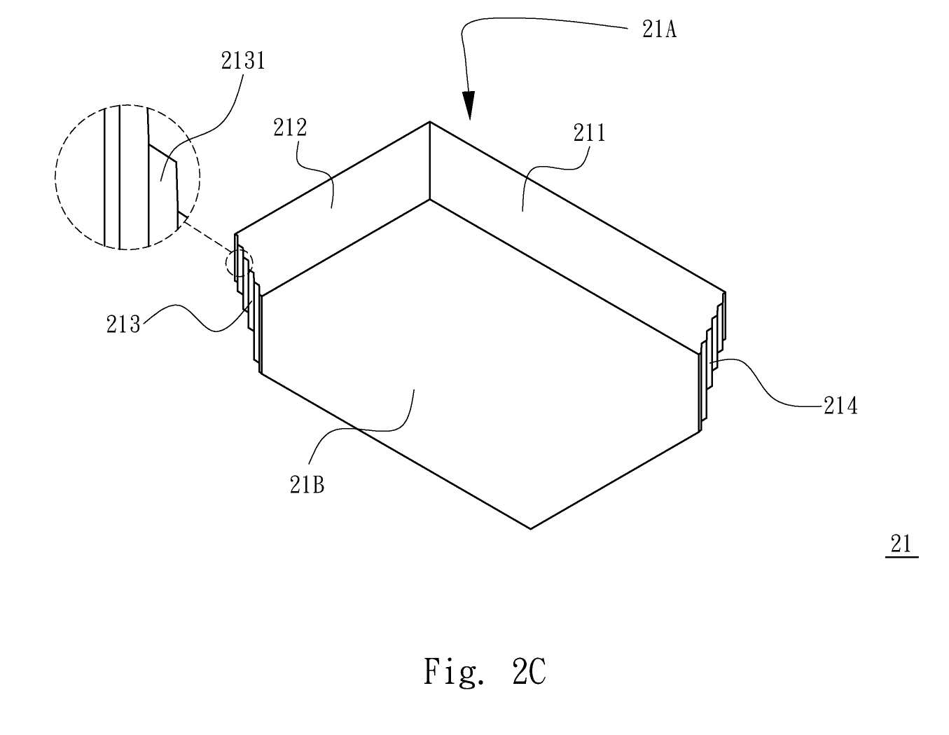

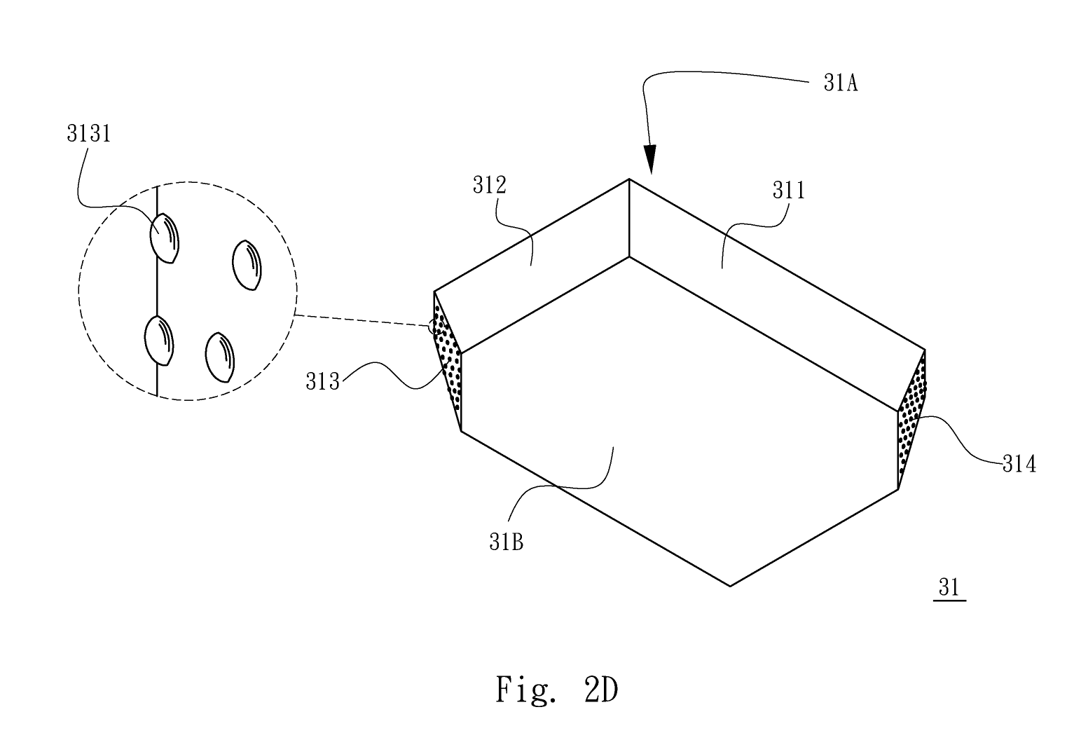

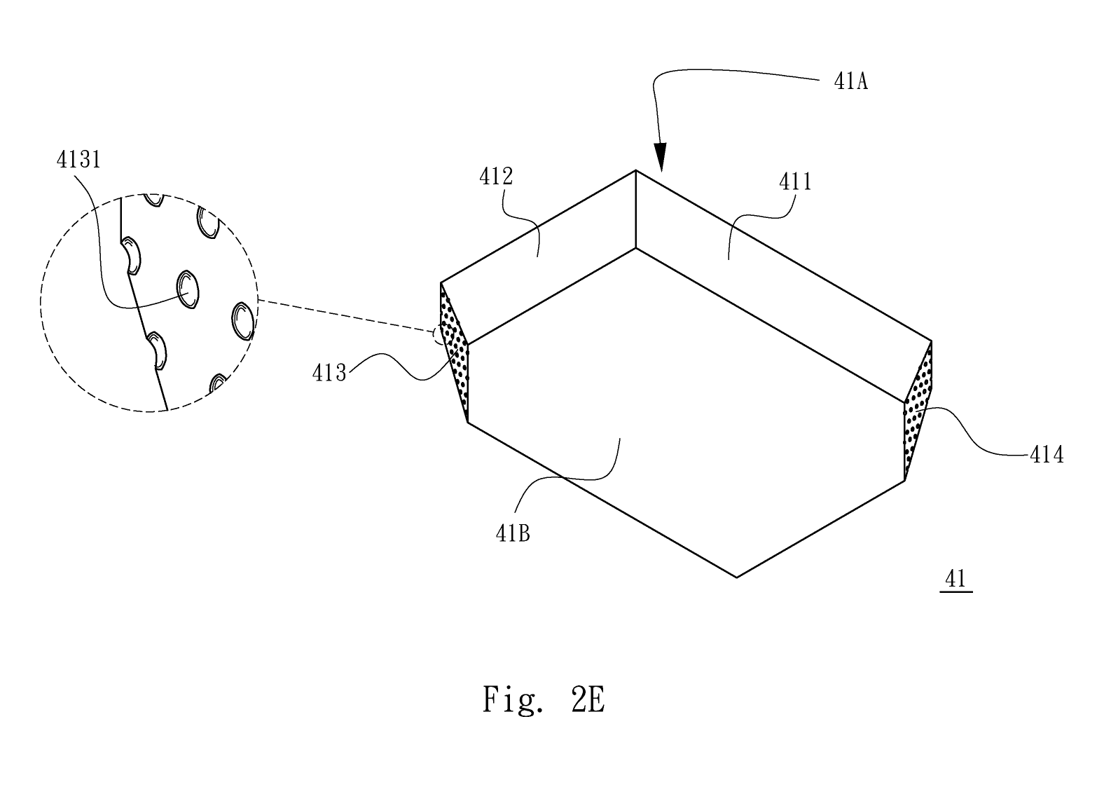

Please refer to FIG. 2A, FIG. 2A is a perspective view of optical element in the composite optical device of first embodiment. As shown in FIG. 2A, the optical element 11 includes a corresponding emitting surface 11A and reflecting surface 11B, a corresponding pair of first lateral 111, a corresponding pair of second lateral 112, a corresponding third lateral 113 and fourth lateral 114. Wherein, the emitting surface 11A and the reflecting surface 11B are both connected to the first lateral 111, the second lateral 112, the third lateral 113 and the fourth lateral 114. In addition, the side length of the third lateral 113 is less than side length of the first lateral 111 and the second lateral 112; the side length of the fourth lateral 114 is less than side length of the first lateral 111 and the second lateral 112. The third lateral 113 is connected to the reflecting surface 11B so as to form a first angle θ 1; the fourth lateral 114 is connected to the reflecting surface 11B so as to form a second angle θ 2. Besides, the material of the optical element 11 can be polymethyl methacrylate (PMMA), polycarbonate (PC), polystyrene (PS), polyethylene (PE) or mixture of at least two aforementioned materials.

In order to diminish “Dark Band Phenomenon,” the aforementioned optical element may be composed. Please refer to FIG. 2A and FIG. 2B simultaneously; FIG. 2B is a top view of the composite optical device of first embodiment. As shown in FIG. 2B, a composite optical device 1 includes pluralities of optical elements 11. The third lateral 113 in each optical element 11 has a space 117 nearby, and the fourth lateral 114 in each optical element 11 has another space 117 nearby. The third lateral 113 is adjacent to the fourth lateral 114 of another optical element 11. A lighting device 12 is disposed in each space 117 to irradiate the light beam passing through the third lateral 113 and then enter the optical element 11. The light beam is reflected inside the optical element 11 by the reflecting surface 11B and then delivered to the first lateral 111, the second lateral 112 and the fourth lateral 114. Finally, the light beam is output through the emitting surface 11A. In addition, the lighting devices 12 are sheltered by the emitting surfaces 11A of the optical elements 11 in order to urge the light beam to enter interior of the optical element 11 and then output through the emitting surface 11A. Moreover, the third lateral 113 may be a polished surface to reduce the loss of light energy when the light beam enters the optical element 11. In this embodiment, the lighting device 12 is a LED. In the composite optical device 1, the optical elements 11 are arranged in order with the number of m in a first direction and with the number of n in a second direction. Wherein, the first direction and the second direction are orthogonal to each other. In the embodiment of FIG. 2B, the first direction is horizontal; the second direction is vertical; m=4 and n=3. Furthermore, those skilled in the art may install the composite optical element 11 with m:n equal to 16:9 or 16:10. After simulation of optical efficiency, the first angle θ 1 or the second angle θ 2 of the optical element 11 may be ranged from 90˜180 degree, 162.5˜178.5 degree the best, to reduce the loss of light energy as far as possible when the light beam passes through the third lateral 113.

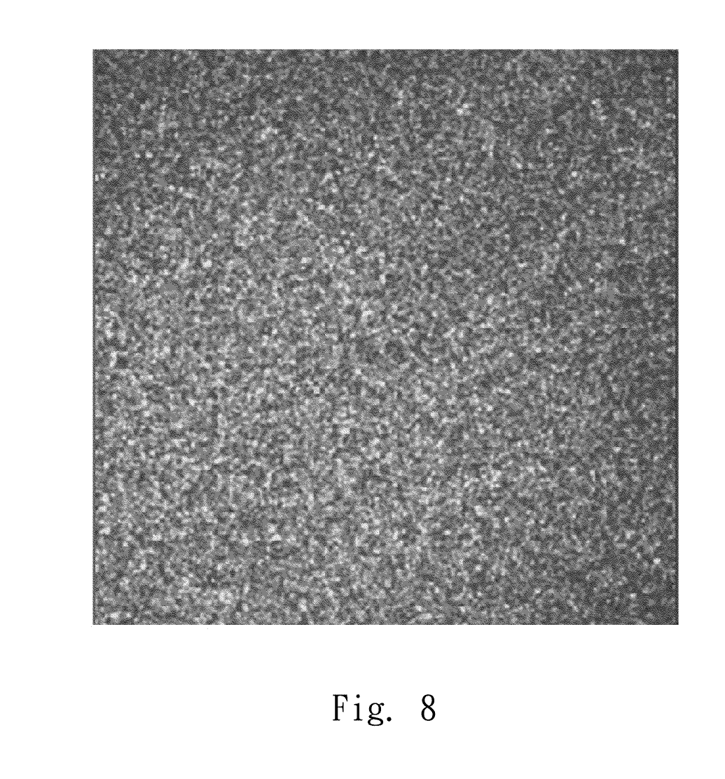

To exemplify the improved result of the composite optical device 1 in present invention, the experiment was raised by optical simulation. Please refer to FIG. 8, FIG. 8 is a diagram of presenting benefit for adopting the composite optical device of first embodiment. As shown in FIG. 8, the “Dark Band Phenomenon” is no more, instead, the light spread with uniform. Thus, the composite optical device 1 may have excellent promotion to diminish the “Dark Band Phenomenon.”

Please refer to FIG. 2C, FIG. 2C is a perspective view of optical element in the composite optical device of second embodiment. In this embodiment, the optical element 21 includes two first laterals 211, two second laterals 212, a third lateral 213, a fourth lateral 214, a emitting surface 21A and a reflecting surface 21B. Wherein, the optical element 21 in FIG. 2C is similar to the optical element 11 in FIG. 2A. As shown in FIG. 2C, the third lateral 213 includes pluralities of microstructures 2131, and the microstructures 2131 are serrate.

Please refer to FIG. 2D, FIG. 2D is a perspective view of optical element in the composite optical device of third embodiment. In this embodiment, the optical element 31 includes two first laterals 311, two second laterals 312, a third lateral 313, a fourth lateral 314, a emitting surface 31A and a reflecting surface 31B. Wherein, the optical element 31 in FIG. 2D is similar to the optical element 11 in FIG. 2A. As shown in FIG. 2D, the third lateral 313 includes pluralities of microstructures 3131, and the microstructures 3131 are convex.

Please refer to FIG. 2E, FIG. 2E is a perspective view of optical element in the composite optical device of fourth embodiment. In this embodiment, the optical element 41 includes two first laterals 411, two second laterals 412, a third lateral 413, a fourth lateral 414, a emitting surface 41A and a reflecting surface 41B. Wherein, the optical element 41 in FIG. 2E is similar to the optical element 11 in FIG. 2A. As shown in FIG. 2E, the third lateral 413 includes pluralities of microstructures 4131, and the microstructures 4131 are concave.

Besides, the microstructure may be disposed on the first, second, fourth lateral or the reflecting surface so as to uniformly reflect the light beam to the emitting surface.

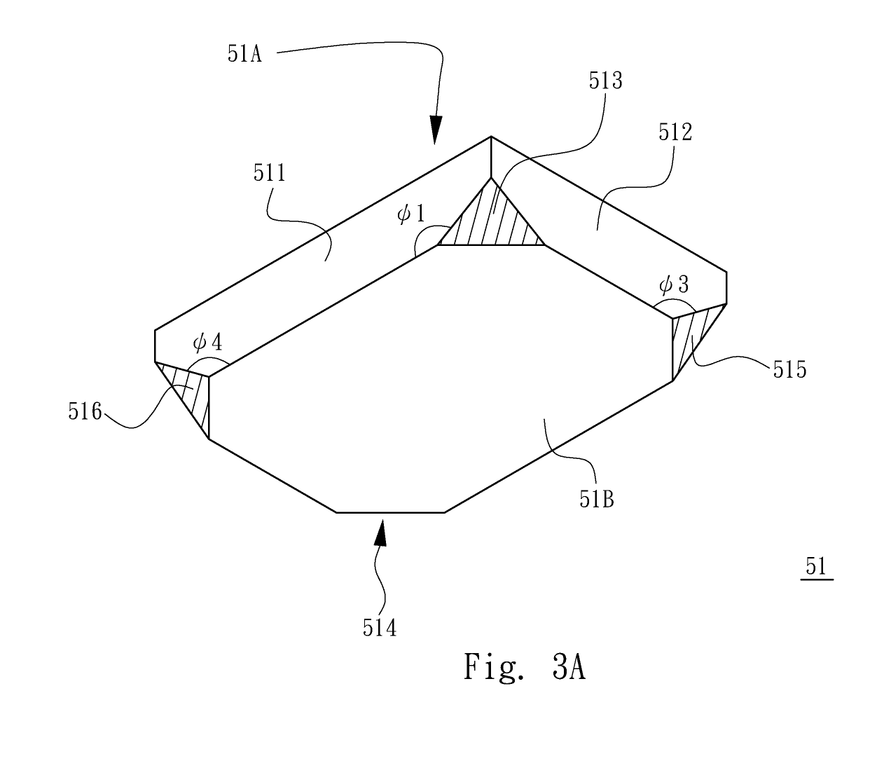

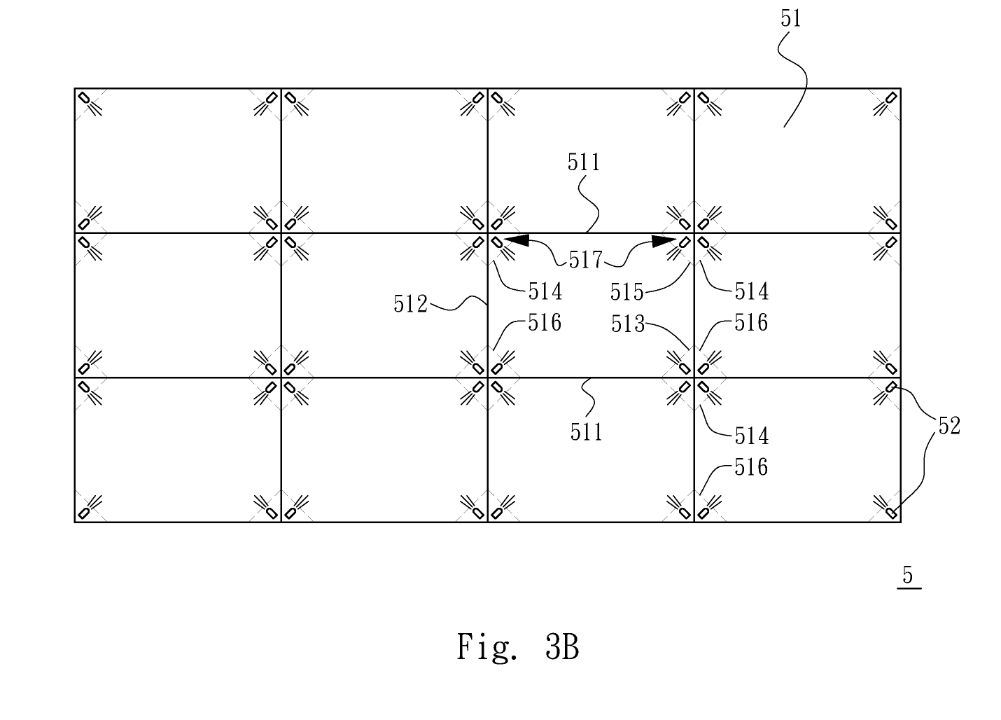

Please refer to FIG. 3A, FIG. 3A is a perspective view of optical element in the composite optical device of fifth embodiment. The optical element 51 includes a corresponding emitting surface 51A and reflecting surface 51B, a corresponding pair of first lateral 511, a corresponding pair of second lateral 512, a corresponding third lateral 513 and fourth lateral 514, a corresponding fifth lateral 515 and sixth lateral 516. In this embodiment, the third laterals 513, fourth laterals 514, fifth laterals 515 and sixth laterals 516 are triangle-shaped. The reflecting surface 51B is connected to the first lateral 511, second lateral 512, third laterals 513, fourth laterals 514, fifth laterals 515 and sixth laterals 516. Besides, the side length of the third lateral 513, fourth lateral 514, fifth lateral 515 and sixth lateral 516 are less than side length of the first lateral 511 or side length of the second lateral 512. The third lateral 513 is connected to the reflecting surface 51B so as to form a first angle ψ 1; the fourth lateral 514 is connected to the reflecting surface 51B so as to form a second angle (not shown); the fifth lateral 515 is connected to the reflecting surface 51B so as to form a third angle ψ 3; the sixth lateral 516 is connected to the reflecting surface 51B so as to form a fourth angle ψ 4.

Please refer to FIG. 3A and FIG. 3B, FIG. 3B is a top view of the composite optical device of fifth embodiment. In FIG. 3B, a composite optical device 5 includes pluralities of optical elements 51 as shown in FIG. 3A. The third lateral 513, fourth lateral 514, fifth lateral 515 and sixth lateral 516, respectively, in each optical element 51 has a space 517 disposed nearby. The third lateral 513 is adjacent to the fourth lateral 514 of another optical element 51; the fifth lateral 515 is adjacent to the sixth lateral 516 of another optical element 51. A lighting device 52 is disposed in each space 517 to irradiate the light beam passing through the third lateral 513, fourth lateral 514, fifth lateral 515 or the sixth lateral 516 and then enter the optical element 51. The light beam is reflected inside the optical element 51 by the reflecting surface 51B and then delivered to the other laterals. Besides, the lighting devices 52 are sheltered by the emitting surfaces 51A of the optical elements 51 in order to urge the light beam to enter interior of the optical element 51 and then output through the emitting surface 51A. The composite optical device 5 is arranged into matrix with four optical elements 51 horizontally and three optical elements 51 vertically. Moreover, after optical simulation, the first angle ψ1, second angle (not shown), third angle ψ3 and fourth angle ψ4 may be ranged 90˜180 degree, 162.5˜178.5 degree the best, to reduce the loss of light energy as far as possible when the light beam passes through the third lateral 513, fourth lateral 514, fifth lateral 515 or the sixth lateral 516.

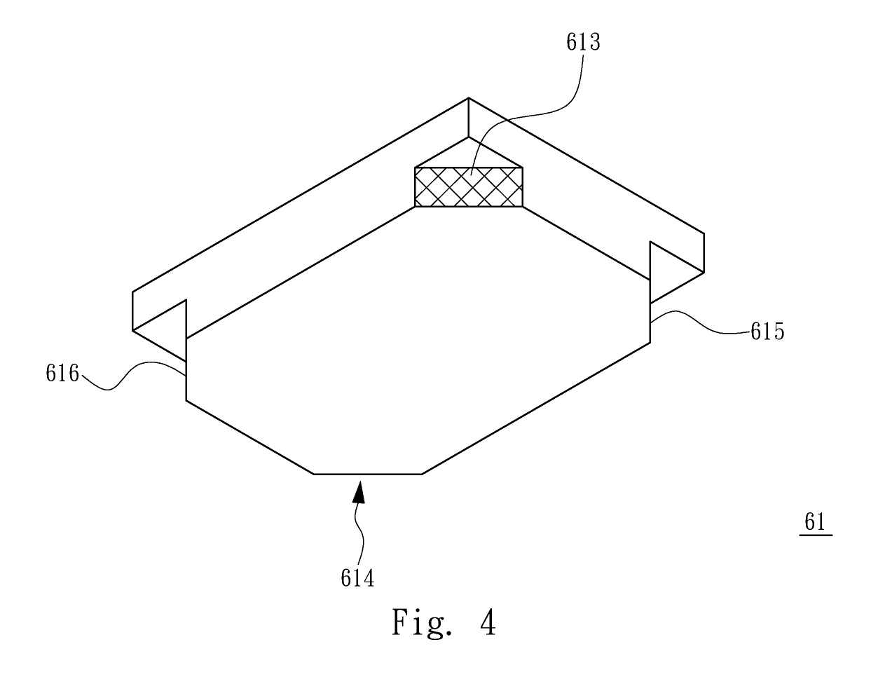

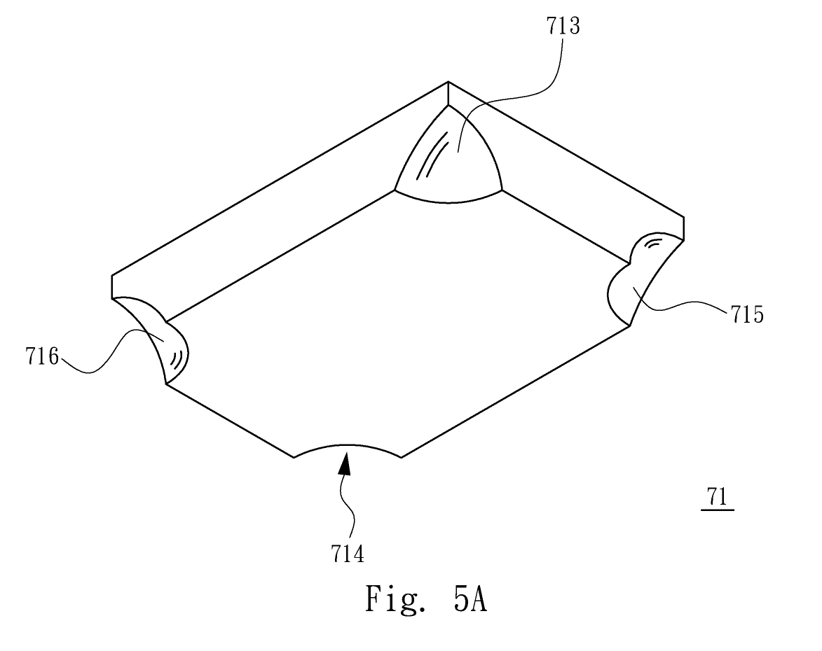

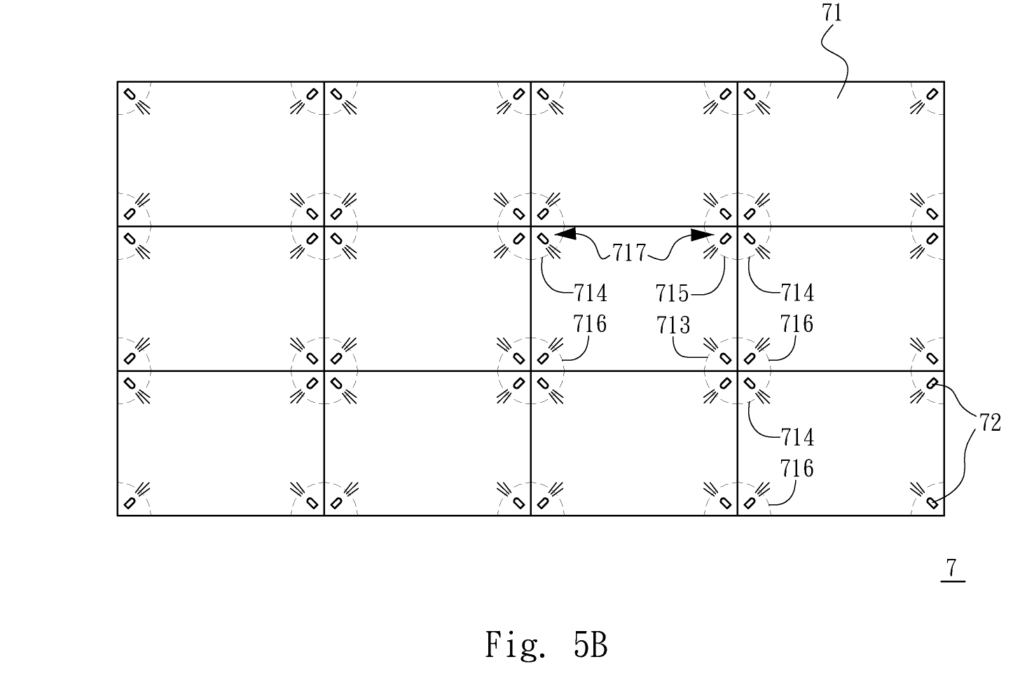

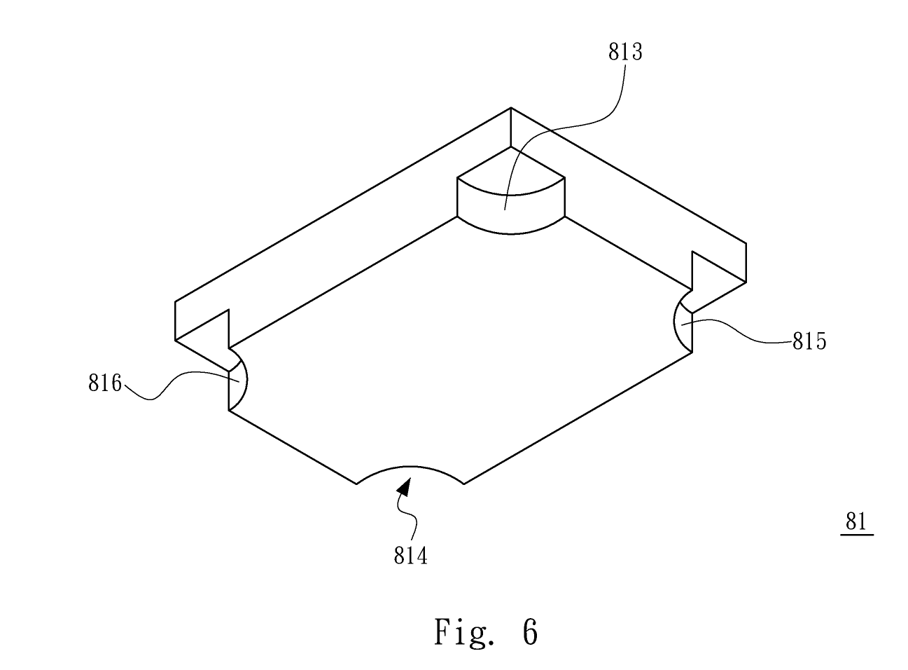

In addition, the third, fourth, fifth or sixth lateral may redesigned with other shape instead of that with triangle-shaped in FIG. 3A. Please refer to FIG. 4, FIG. 5A and FIG. 6, FIG. 4 is a perspective view of optical element in the composite optical device of sixth embodiment; FIG. 5A is a perspective view of optical element in the composite optical device of seventh embodiment; FIG. 6 is a perspective view of optical element in the composite optical device of eighth embodiment. In FIG. 4, the third lateral 613, fourth lateral 614, fifth lateral 615 and sixth lateral 616 of the optical element 61 are quadrilateral-shaped. In FIG. 5A, the third lateral 713, fourth lateral 714, fifth lateral 715 and sixth lateral 716 of the optical element 71 are curved surface. In FIG. 6, the third lateral 813, fourth lateral 814, fifth lateral 815 and sixth lateral 816 of the optical element 81 are cylindrical. Moreover, please refer to FIG. 5B, FIG. 5B is a top view of the composite optical device of seventh embodiment. In FIG. 5B, the composite optical device 7 is composed of pluralities of optical elements 71 as shown in FIG. 5A. In the composite optical device 7, the third lateral 713, fourth lateral 714, fifth lateral 715 and sixth lateral 716 in each optical element 71 have a space 717 nearby, respectively. The third lateral 713 is adjacent to the fourth lateral 714 of another optical element 71; the fifth lateral 715 is adjacent to the sixth lateral 716 of another optical element 71. A lighting device 72 is disposed in each space 717 to irradiate the light beam passing through the third lateral 713, fourth lateral 714, fifth lateral 715 or sixth lateral 716 and then enter the optical element 71.

Thus, the composite optical device of present invention which adopts the optical elements may diminish the “Dark Band Phenomenon” occurred in edge-type backlight module which contains LEDs. In this reason, the uniformity of luminance shall be improved and then the display efficiency of monitor will be definitely better.

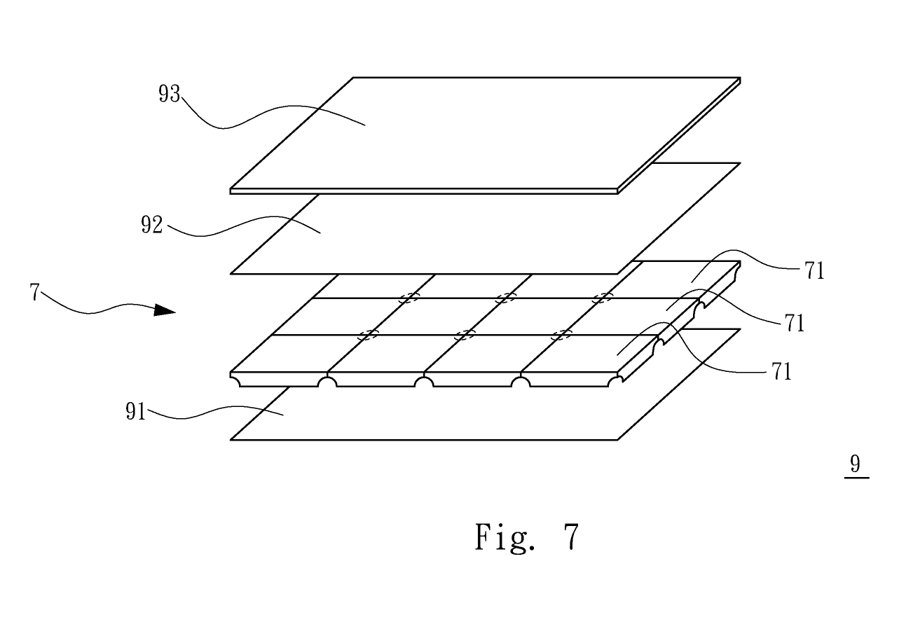

In order to prove the validation of the optical element or the composite optical device, the monitor which adopts aforementioned optical element or composite optical device is introduced. Please refer to FIG. 7, FIG. 7 is a perspective view of monitor with composite optical device. In FIG. 7, a monitor 9 includes a backboard 91, a composite optical device 7, an optical diffusive layer 92 and a LCD panel 93. Wherein, the composite optical device 7 is exactly the same with the one in FIG. 5B. The backboard 91 is disposed underneath the composite optical device 7 in order to reflect light beam leaked from the composite optical device 7. The optical diffusive layer 92 is disposed at upside of the composite optical device 7 in order to receive the light energy emitted from the composite optical device 7, and so as to form a specific optical path. The LCD panel 93 is disposed at upside of the optical diffusive layer 92. After the light beam goes from the optical diffusive layer 92 to the LCD panel 93, a predesigned image may be presented.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

I claim:

1. A composite optical device comprising:
pluralities of optical elements, each optical element including a corresponding pair of surfaces, a corresponding pair of first laterals, a corresponding pair of second laterals, a corresponding third lateral and fourth lateral, wherein at least one surface is connected to said first lateral, said second lateral, said third lateral and said fourth lateral, the side length of said third lateral being less than side length of said first lateral and said second lateral, the side length of said fourth lateral being less than side length of said first lateral and said second lateral, at least one third lateral and one fourth lateral having a space, said third lateral being adjacent to the fourth lateral of another optical element;
pluralities of lighting devices, each lighting device being disposed in said space;
an emitting surface being one of corresponding pair of surfaces;
a reflecting surface being another of corresponding pair of surfaces;
whereby at least one of said third lateral and said fourth lateral receive the light energy of said lighting device and then said optical element delivers the light beam to said first lateral, said second lateral, said third lateral and said fourth lateral by means of the reflection of said reflecting surface, the light beam being output through said emitting surface.

2. The composite optical device of claim 1, wherein said reflecting surface or at least one lateral includes pluralities of microstructures.

3. The composite optical device of claim 2, wherein said microstructures are convex or concave.

4. The composite optical device of claim 1, wherein the pluralities of optical elements are arranged in order with the number of m in a first direction and with the number of n in a second direction, said first direction and said second direction being orthogonal to each other thereof, m: n being equal to 16:9 or 16:10.

5. The composite optical device of claim 1, wherein said third lateral is connected to one of said corresponding pair of surfaces so as to form a first angle.

6. The composite optical device of claim 1, wherein said fourth lateral is connected to one of said corresponding pair of surfaces so as to form a second angle.

7. The composite optical device of claim 1, wherein the material of said optical element is polymethyl methacrylate (PMMA), polycarbonate (PC), polystyrene (PS), polyethylene (PE) or mixture of at least two aforementioned materials.

8. A composite optical device comprising:
pluralities of optical elements, each optical element including a corresponding pair of surfaces, a corresponding pair of first laterals, a corresponding pair of second laterals, a corresponding third lateral and fourth lateral, and a corresponding fifth lateral and sixth lateral, wherein at least one surface is connected to said first lateral, said second lateral, said third lateral, said fourth lateral, said fifth lateral and said sixth lateral, the side length of said third lateral being less than side length of said first lateral and said second lateral, the side length of said fourth lateral being less than side length of said first lateral and said second lateral, the side length of said fifth lateral being less than side length of said first lateral and said second lateral, the side length of said sixth lateral being less than side length of said first lateral and said second lateral, at least one third lateral and one fourth lateral having a space, said third lateral being adjacent to the fourth lateral of another optical element, at least one fifth lateral and one sixth lateral having a space, said fifth lateral being adjacent to the sixth lateral of another optical element;
pluralities of lighting devices, each lighting device being disposed in said space;
an emitting surface being one of corresponding pair of surfaces;
a reflecting surface being another of corresponding pair of surfaces;
whereby at least one of said third lateral, said fourth lateral, said fifth lateral and said sixth lateral receive the light energy of said lighting device and then said optical element delivers the light beam to said first lateral, said second lateral, said third lateral, said fourth lateral, said fifth lateral and said sixth lateral by means of the reflection of said reflecting surface, the light beam being output through said emitting surface.

9. The composite optical device of claim 8, wherein said reflecting surface or at least one lateral includes pluralities of microstructures.

10. The composite optical device of claim 9, wherein said microstructures are convex or concave.

11. The composite optical device of claim 8, wherein the pluralities of optical elements are arranged in order with the number of m in a first direction and with the number of n in a second direction, said first direction and said second direction being orthogonal to each other thereof, m:n being equal to 16:9 or 16:10.

12. The composite optical device of claim 8, wherein said third lateral is connected to one of said corresponding pair of surfaces so as to form a first angle.

13. The composite optical device of claim 8, wherein said fourth lateral is connected to one of said corresponding pair of surfaces so as to form a second angle.

14. The composite optical device of claim 8, wherein said fifth lateral is connected to one of said corresponding pair of surfaces so as to form a third angle.

15. The composite optical device of claim 8, wherein said sixth lateral is connected to one of said corresponding pair of surfaces so as to form a fourth angle.

16. A monitor with composite optical device, comprising:
pluralities of optical elements, each optical element including a corresponding pair of surfaces, a corresponding pair of first laterals, a corresponding pair of second laterals, a corresponding third lateral and fourth lateral, wherein at least one surface is connected to said first lateral, said second lateral, said third lateral and said fourth lateral, the side length of said third lateral being less than side length of said first lateral and said second lateral, the side length of said fourth lateral being less than side length of said first lateral and said second lateral, at least one third lateral and one fourth lateral having a space, said third lateral being adjacent to the fourth lateral of another optical element;
pluralities of lighting devices, each lighting device being disposed in said space;
an emitting surface being one of corresponding pair of surfaces;
a reflecting surface being another of corresponding pair of surfaces; whereby at least one of said third lateral and said fourth lateral receive the light energy of said lighting device and then said optical element delivers the light beam to said first lateral, said second lateral, said third lateral and said fourth lateral by means of the reflection of said reflecting surface, the light beam being output through said emitting surface;
at least one optical diffusive layer disposed outside said emitting surface, wherein said optical diffusive layer receives the light energy emitted from said emitting surface so as to form a specific optical path;
a LCD panel disposed next to said optical diffusive layer, wherein said LCD panel receives the optical path so as to present a predesigned image.

17. The monitor of claim 16, wherein said reflecting surface or at least one lateral includes pluralities of microstructures.

18. The monitor of claim 17, wherein said microstructures are convex or concave.

19. The monitor of claim 16, wherein the pluralities of optical elements are arranged in order with the number of m in a first direction and with the number of n in a second direction, said first direction and said second direction being orthogonal to each other thereof, m:n being equal to 16:9 or 16:10.

20. The monitor of claim 16, wherein the material of said optical element is polymethyl methacrylate (PMMA), polycarbonate (PC), polystyrene (PS), polyethylene (PE) or mixture of at least two aforementioned materials.
